(19) United States
(12) Patent Application Publication
(10) Pub. No.: US 2021/0124562 A1
(43) Pub. Date: Apr. 29, 2021

(54) CONVERSATIONAL USER INTERFACE AGENT DEVELOPMENT ENVIRONMENT

(71) Applicant: Microsoft Technology Licensing,LLC, Redmond, WA (US)

(72) Inventors: Vishwac Sena KANNAN, Redmond, WA (US); Kristoffer SCHULTZ, Redmond, WA (US); Vikram BAPAT, Kirkland, WA (US); Rob CHAMBERS, Sammamish, WA (US); Aleksandar UZELAC, Seattle, WA (US); Khuram SHAHID, Seattle, WA (US); Adina Magdalena TRUFINESCU, Redmond, WA (US)

(73) Assignee: Microsoft Technology Licensing,LLC, Redmond, WA (US)

(21) Appl. No.: 16/949,430

(22) Filed: Oct. 29, 2020

Related U.S. Application Data
(63) Continuation of application No. 15/636,503, filed on Jun. 28, 2017.
(60) Provisional application No. 62/418,068, filed on Nov. 4, 2016.

(51) Int. Cl. G06F 8/34; G06F 3/0482; G06F 3/0484; G10L 15/18; G06F 3/16; G10L 15/22; G06F 40/30

(52) U.S. Cl. CPC G06F 8/34; G06F 3/0482; G06F 3/04847; G06F 40/242; G06F 3/167; G10L 15/22; G06F 40/30; G10L 15/1815

(57) ABSTRACT

One disclosed example provides a computing system configured to receive input defining a machine conversation dialog flow, display in an editing user interface a first representation of the machine conversation dialog flow in the form of a symbolic representation, receive input requesting display of a second representation of the machine conversation dialog flow, and in response to the request display in the editing user interface the machine conversation dialog flow in the character-based representation. The computing system is further configured to, based upon the machine conversation dialog flow, update a machine conversation schema template to form an updated machine conversation schema, and form an agent definition file based upon the updated machine conversation schema for use in executing the machine conversation dialog flow.

### CROSS REFERENCE TO RELATED APPLICATIONS

This application is a continuation of U.S. patent application Ser. No. 15/636,503, filed Jun. 28, 2017, which claims priority to U.S. Provisional Patent Application No. 62/418,068, filed Nov. 4, 2016, the entirety of each of which is hereby incorporated herein by reference.

### BACKGROUND

Computing device user interfaces implemented as conversation flows are becoming increasingly common. Such user interfaces may be configured to accept a single user utterance as an input, or to conduct a multi-step conversational dialog flow in which the computer and a user exchange multiple queries and responses.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to a development environment for designing conversational user interfaces. One example provides a computing system comprising a logic subsystem and a data-holding subsystem. The data-holding subsystem comprises instructions executable by the logic subsystem to receive input defining a machine conversation dialog flow, display in an editing user interface a first representation of the machine conversation dialog flow in the form of a symbolic representation, receive input requesting display of a second representation of the machine conversation dialog flow, and in response to the request display in the editing user interface the machine conversation dialog flow in the character-based representation. The instructions are further executable to, based upon the machine conversation dialog flow, update a machine conversation schema template to form an updated machine conversation schema, and form an agent definition file based upon the updated machine conversation schema for use in executing the machine conversation dialog flow.

Another example provides a computing system comprising a logic subsystem and a data-holding subsystem comprising computer-readable instructions executable by the logic system to operate an agent development environment. The tool is configured to receive input defining a machine conversation dialog flow, display an editable representation of the machine conversation dialog flow in an editing field of a user interface of the agent development environment, receive an input selecting a state within the machine conversation dialog flow displayed in the editing field, and in response, display in a preview field of the user interface a preview of the state within the machine conversation dialog flow as the state would be presented during runtime. The tool is further configured to, based upon the input defining the machine conversation dialog flow, update a machine conversation schema template to form an updated machine conversation schema, and form an agent definition file based upon the updated machine conversation schema for use in executing the machine conversation dialog flow.

Another example provides a computing system comprising a logic subsystem and a data-holding subsystem comprising computer-readable instructions executable by the logic system. The instructions are executable to receive input defining a machine conversation dialog flow, based upon the input, modify a machine conversation schema template to form an agent definition, and receive an input granting of access to the agent definition, the input defining user accounts with which to grant access to the agent definition. The instructions are further executable to grant access to the machine conversation dialog flow to the user accounts defined, receive feedback regarding testing usage of the agent definition by the user accounts, receive an input requesting display of a representation of the feedback regarding testing usage of the agent definition from the user accounts, and in response, display a representation of the machine conversation dialog flow and the representation of the feedback at one or more locations within the representation of the machine conversation dialog flow.

### BRIEF DESCRIPTION OF THE DRAWINGS

FIG. 1 is a block diagram illustrating an example architecture for an agent development environment.

FIG. 2 illustrates examples of a user interface of the agent development environment and dialog tools which may be incorporated into a dialog flow.

FIG. 3 illustrates an example editing user interface showing a machine conversation dialog flow.

FIG. 4 illustrates states and transitions of an example dialog flow reference in the editing user interface.

FIG. 5 illustrates an example character-based script visualization of a dialog flow in the editing user interface.

FIG. 6A-6B illustrate user interfaces of an example agent development tool.

FIG. 7 illustrates a user interface of an example UI preview region of the agent development tool.

FIGS. 8A-B illustrate an example UI showing a preview of visual elements obtained from outside an operating environment of an agent development tool.

FIG. 9 illustrates an example UI of an agent development tool for displaying feedback from testing usage.

FIGS. 10-12B show example user interfaces illustrating examples of analytic feedback provided by an agent development tool.

FIG. 13 illustrates an example UI for a language understanding model designer.

FIG. 14 illustrates an example UI for assigning a language understanding model to a dialog flow.

FIG. 15A-15B show examples of a dialog flow adapted to different digital contexts.

FIG. 16 shows an example schema template that is adaptable to generate a schema for an agent definition.

FIGS. 17A-B show an example agent schema generated from a schema template by an agent generator of an agent development environment.

FIG. 18 shows a block diagram of an example computing device.

### DETAILED DESCRIPTION

As mentioned above, a computing device user interface may be implemented in the form of a conversational dialog flow conducted via speech or text. Conversation-based user interfaces may be used to perform a wide variety of tasks. For example, a digital personal assistant, which may take the form of a software module on a mobile phone or desktop computer, may utilize conversation-based user inputs to book a reservation at a restaurant, order food, set a calendar reminder, and/or order movie tickets with the proper conversation design. Likewise, bots may be used as conversational interfaces for carrying out many types of transactions.

A conversation-based user interface may be implemented as a conversational agent definition, referred to herein as an agent definition, that defines the conversation flow between a user and a computing device. As different inputs and outputs may be provided for different types of computing devices and in different computing contexts, it may be difficult to efficiently adapt a conversation (e.g. for making a restaurant reservation) authored for one computing device context, such as mobile, to a different context, such as desktop, holographic, small screen, or audio-only. As such, a developer may have to develop a different agent for each desired context in which the developer wishes to use a particular conversation flow.

Accordingly, examples are disclosed herein that relate to an agent development environment configured to facilitate the development of conversational user interface flows and the adaption of an authored conversational user interface flow across a variety of computing contexts. As one example, a developer creating a website for a delicatessen may author a machine conversation dialog flow for a website application that comprises states specifying, for example, the types of breads, meats, cheeses and spreads a customer may choose to build a sandwich. The agent development environment may then facilitate the reuse of that conversation across multiple platforms, for example, as a bot conversation on the website of the delicatessen, an SMS-based ordering platform in which users could use text-messaging to respond to text prompts in order to build a sandwich, and/or as an audio-only conversational interface in which a visitor may speak with a bot equipped with language understanding and language generating modules (e.g. for use in an automobile context). The tool further permits the developer to preview the user interfaces for each state in the conversation flow under development in each of a variety of device contexts, and also preview a runtime simulation of the conversation flow, without having to manually adapt the machine conversation for each desired context or code control logic for executing the runtime simulation.

Further, the disclosed examples also provide for the presentation of a conversation flow under development in different views, such that a user may choose to view a conversation flow under development in a symbolic view (e.g. as a flow diagram), in a character-based view (e.g. as a script that represents the conversation flow as text-based code), and/or in various other views. The disclosed examples further allow a conversation flow under development to be tested by a defined group of other users for the purpose of gathering testing usage feedback, and to present feedback from such testing usage feedback as markup to a displayed view of the conversation flow under development, illustrating various statistical information gathered from the testing process at each conversation state and/or transition.

When authoring a machine conversation dialog flow, a developer may specify various information for the flow, such as information regarding a domain, one or more intents associated with the domain, one or more slots for a domain-intent pair, one or more states for an intent, transitions between states, and response templates for the flow. A domain is a category which encompasses a group of functions for a module or tool, an intent is at least one action used to perform at least one function of a category of functions for an identified domain, and a slot is a specific value or set of values used for completing a specific action for a given domain-intent pair. For example, an “alarm time” slot may be specified for a “set an alarm” intent in the “alarm” domain.

After the dialog flow for performing the desired agent functionalities has been structured by a developer, the agent development environment updates a schema template using the information provided to the agent development environment by the user. The schema formed by updating the schema template, in combination with code to implement business logic of the conversation flow and potentially other control logic (e.g. transitional control) of the conversation flow, forms the agent definition. The schema template may comprise a document (e.g. implemented as XML or another type of computer-readable document) with code segments defining the states of a machine conversation dialog flow. As such, the term “agent” may represent any suitable data/command structure which may be used to implement, via a runtime environment, a conversation flow associated with a device functionality. The code that implements business logic may be entered by a developer, for example, when building the agent definition. Code for controlling the conversation flow likewise may be entered by the developer, or may be provided by a runtime environment in which the agent is executed.

The agent definition may be configured for a specific operating and/or device context, (e.g. a bot, personal assistant, or other computing device interface), or may be configured to execute in multiple different contexts, e.g. by including in the schema input and output options for each of the multiple different contexts at relevant states in the conversation flow.

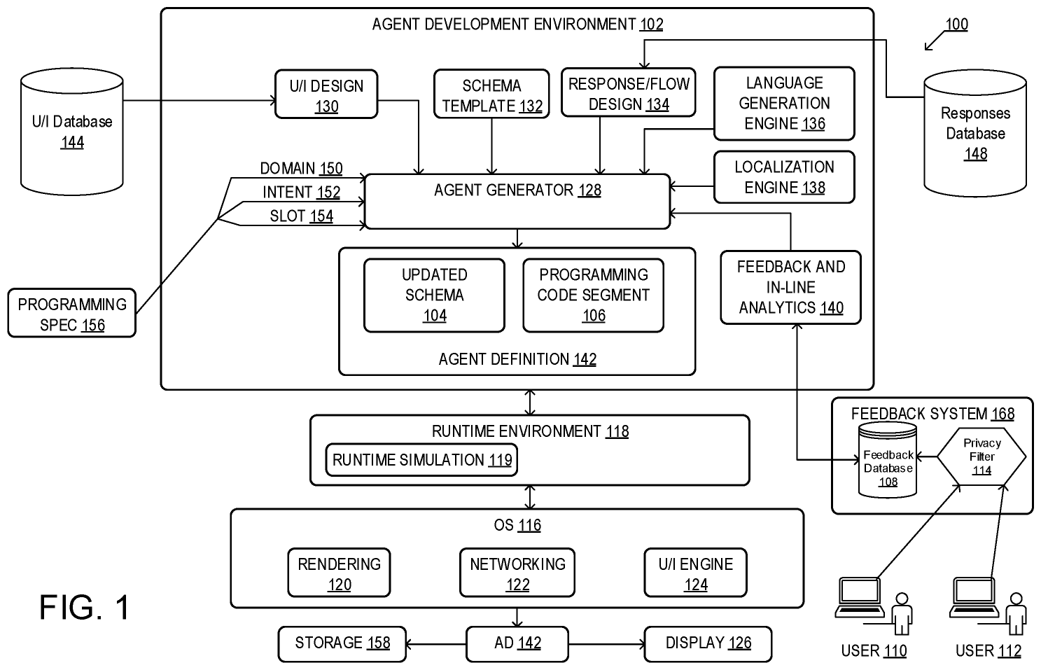

FIG. 1 shows a block diagram illustrating an example software architecture 100 for implementing an agent development environment 102. In addition to the agent development environment 102, the architecture 100 includes a device operating system (OS) 116, a runtime environment 118 and a feedback system 168. Each of these components, or any combination of these components, may be hosted locally on a developer computer and/or remotely, e.g. at a cloud-based service.

In FIG. 1, the device OS 116 includes components for rendering 120 (e.g., rendering visual output to a display and/or generating voice output for a speaker), components for networking 122, and a user interface (U/I) engine 124. The U/I engine 124 may be used to generate one or more graphical user interfaces (e.g., such as the examples described below) in connection with agent development environment functionalities of the agent development environment 102. The user interfaces may be rendered on display 126, using the rendering component 120. Input received via a user interface generated by the U/I engine 124 may be communicated to the agent generator 128. The device OS 116 manages user input functions, output functions, storage access functions, network communication functions, and other functions for a device on which the OS is executed. The device OS 116 provides access to such functions to the agent development environment 102.

The agent development environment 102 may comprise suitable logic, circuitry, interfaces, and/or code, and may be operable to provide functionalities associated with agent definitions (including generating and editing such definitions), as explained herein. The agent development environment 102 may comprise an agent generator 128, U/I design block 130, a schema template block 132, response/flow design block 134, language generation engine 136, a localization engine 138, and a feedback and in-line analytics module 140. The agent development environment 102 may include a visual editing tool, as described in more detail below, and/or any other suitable editing tools. As another example, a development environment may have a combination of different documents and views coming together to capture an agent definition. As a more detailed example, a conversation flow may be captured in a first document, and the responses captured in a second document. Such a development environment may help streamline the authoring experience by bringing these separate documents together.

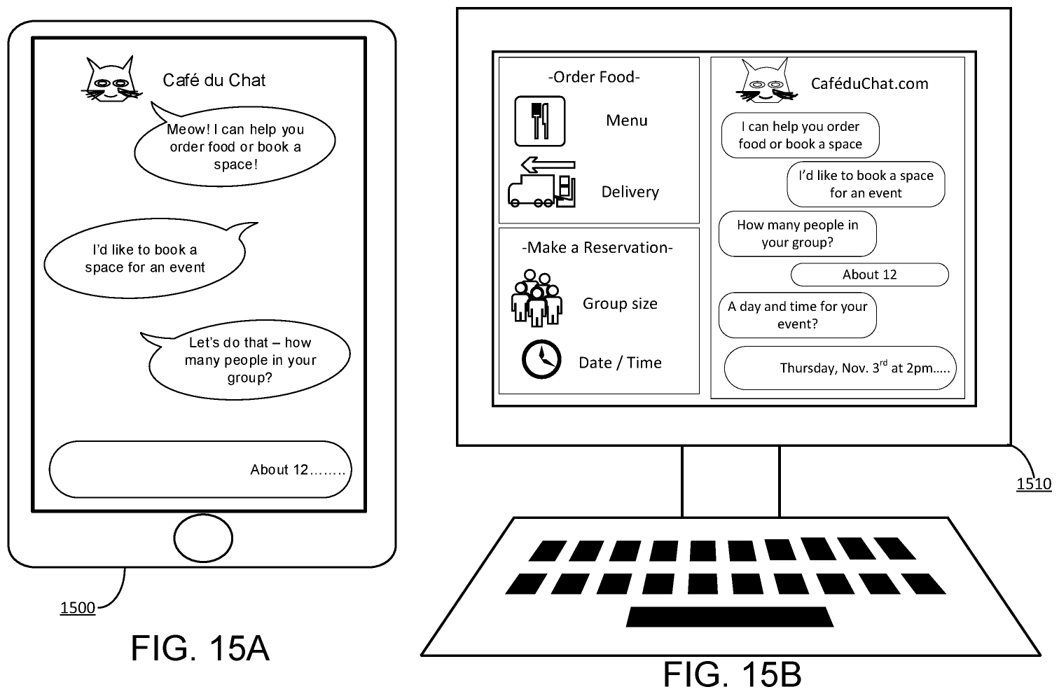

The schema template block 132 may be operable to provide a schema template, such as the template shown in FIG. 15. The schema template may include a plurality of code sections, which are updated (e.g., by the agent generator 128) based upon an authored machine conversation dialog flow in order to provide an updated schema 104 for an agent definition 142.

The U/I design 130 may comprise suitable logic, circuitry, interfaces, and/or code (e.g. retrieved from U/I Database 144), and may be operable to generate and provide to the agent generator 128 one or more user interfaces for use with the agent definition 142.

The response/flow design module 134 may comprise suitable logic, circuitry, interfaces, and/or code to provide one or more response strings for use by the agent generator 128. For example, response strings (and presentation modes for the response strings) may be selected from responses database 148. The language generation engine 136 may be used to generate one or more human-readable responses, which may be used in connection with a given domain-intent-slot configuration (e.g., based on inputs 150, 152 and 154). The response/flow design module 134 may also provide the agent generator 128 with flow design in connection with a machine conversation dialog flow.

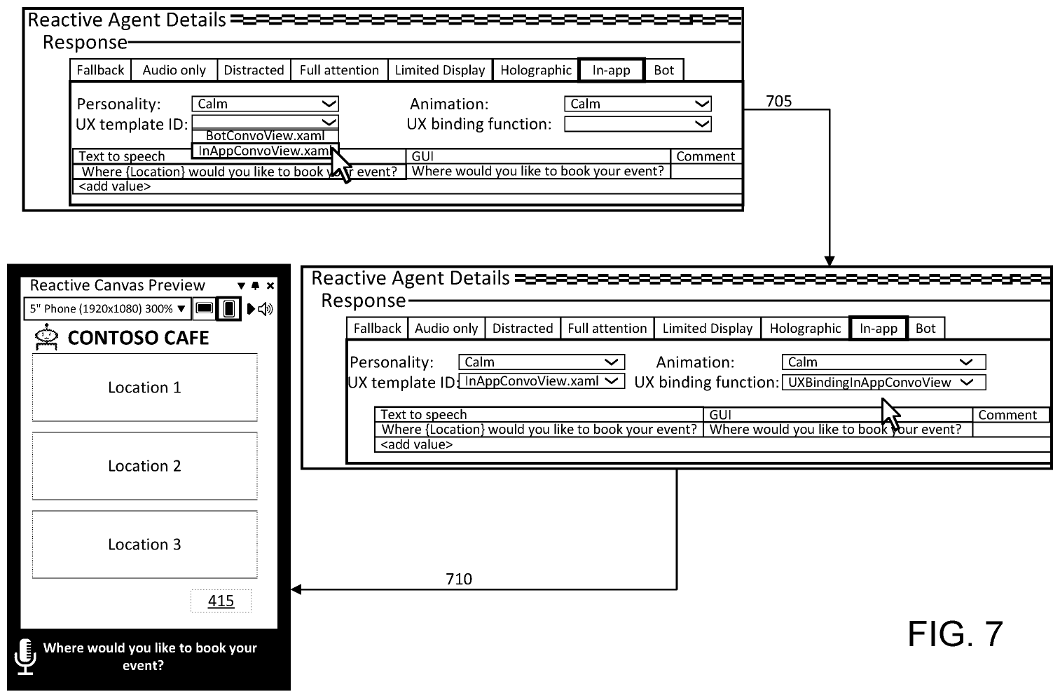

In an example, for an agent definition 142 generated by the agent generator 128, the selection of response strings and/or presentation mode for such responses may be based upon the digital context chosen by the developer for the agent definition as well as any number of factors, such as a user's distance from a device, the user's posture, noise level, current user activity, or social environment around user. As described below in more detail with regard to FIG. 7, the agent development environment may allow a developer to designate a plurality of contexts in which the conversation may be implemented, such as mobile, desktop/laptop, holographic, limited screen (e.g. smart watch), and bot contexts.

The agent generator 128 may receive input from a programming specification 156. For example, the programming specification 156 may specify a domain, one or more intents, and one or more slots, via inputs 150, 152 and 154 respectively. The agent generator 128 may also acquire the schema template 132 and generate an updated schema 104 based on, for example, user input received via the U/I design module 130. Response/flow input from the response/flow design module 134, as well as localization input from the localization engine 138, may be used by the agent generator 128 to further update the schema template 132 and generate the updated schema 104. An additional programming code segment 106 may also be generated (e.g. based upon user input of code) to implement and manage performing of one or more requested functions by a digital personal assistant, bot, and/or computing device (e.g. to implement business logic). The updated schema 104 and the programming code segment 106 may be combined to generate the agent definition 142. The agent definition 142 may then be output to a display 126 and/or stored in storage 158 in some operating contexts.

Runtime environment 118 comprises suitable logic, circuitry, interfaces, and/or code to execute a machine conversation dialog flow defined by an agent definition. The runtime environment 118 may be implemented as a portable library configured to interpret and execute state transitions of a machine conversation flow defined by the agent definition. By implementing the conversation runtime, bot-specific execution code does not have to be rewritten by a developer each time a different bot is created. This may simplify the development of agent definitions, and thus allow conversational interfaces to be more efficiently developed. Further, language understanding and language generation can be shared across agents to allow assets to be reused across a larger developer ecosystem. Runtime simulation 119 may be utilized by agent development environment 102 to provide runtime simulations for a machine conversation dialog flow under development.

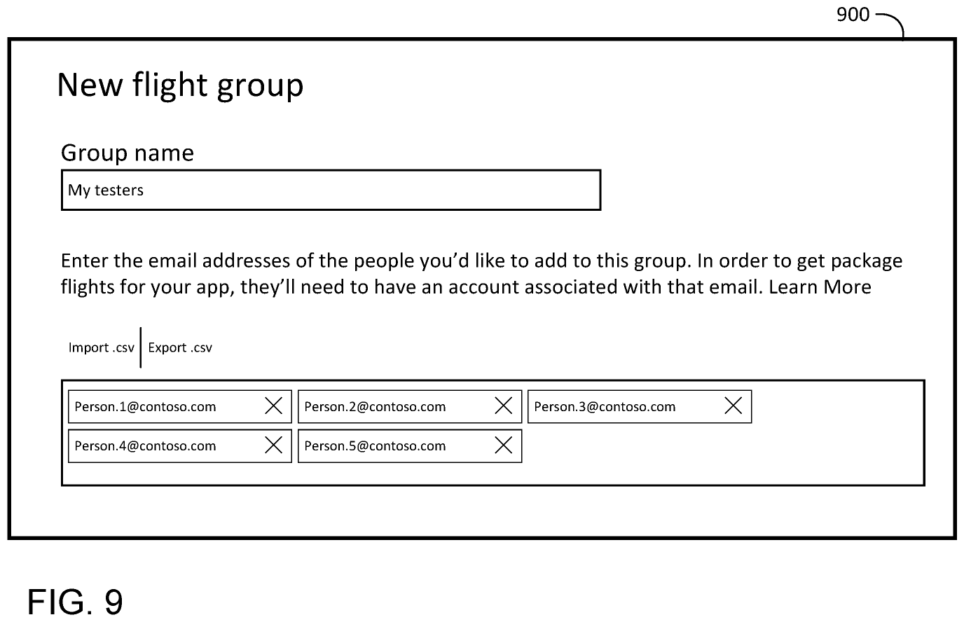

The feedback system 168 is configured to gather and present testing usage data from other users 110, 112 to test a machine conversation dialog flow under development. Testing usage metrics are gathered from users 110, 112 via telemetry and stored in a feedback database 108 after passing through a privacy filter 114 to remove personal information regarding the users. Example feedback is described in more detail below with regard to FIGS. 9-12.

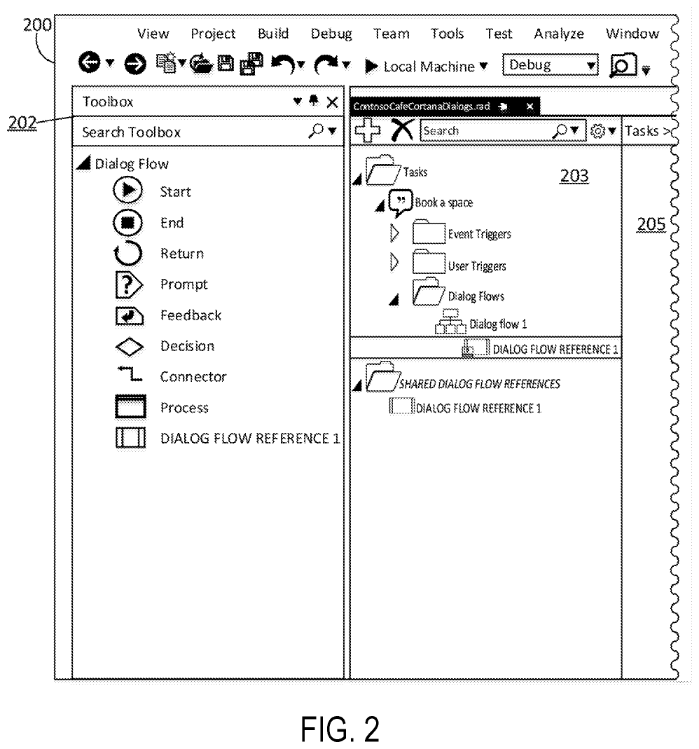

FIG. 2-4 show an example user interface 200 of the agent development environment in which a machine conversation dialog flow may be authored by a developer, and illustrate an example dialog flow for making a reservation at a café for a meal. Referring first to FIG. 2, the user interface 200 comprises a toolbox 202 containing representations of state elements and state transition elements, or dialog tools, which may be incorporated into a dialog flow being authored in an editing user interface 205. It will be understood that the depicted UI features are shown for example, and that the described UI functionalities may be incorporated into any other suitable UI design. The dialog tools may be used to provide a flow diagram representation of states, transitions, and transition conditions for specifying a machine conversation dialog flow between a human and a digital personal assistant, bot, or other non-human, conversable digital entity.

The user interface 200 further comprises a taskbar 203 that illustrates event triggers and user triggers that a developer may create and/or modify. For example, a developer may create a user trigger to define the user voice commands configured to initiate the machine conversation in runtime. In some examples, a set of slots (e.g. date, location, time) may capture entities from voice commands that may be stored as parameters to define the user trigger. Alternatively or additionally, a developer may create an event trigger to automatically initiate a task. For example, a developer may select an upcoming event as a trigger to initiate the machine conversation in runtime.

Taskbar 203 also illustrates a hierarchical organization of the dialog flow under development. As illustrated, a machine conversation dialog flow may be organized into one or more dialog flow references, wherein each dialog flow reference may contain its own conversation sub-flow. Taskbar 203 may allow for efficient re-use of dialog flows within flow references in a larger dialog flow. For example, if a dialog flow that pertains to making a dinner reservation comprises “setTime” and “setDate” dialog flow references, the “setTime” and “setDate” dialog flow references may be re-used if the developer decides to create a plurality of states in which the conversation asks a user to input dates and times. As part of the dinner reservation example, the conversation flow may request user input of multiple dates and times for dinner reservations, in order of preference, should the first-preferred date and time not be available.

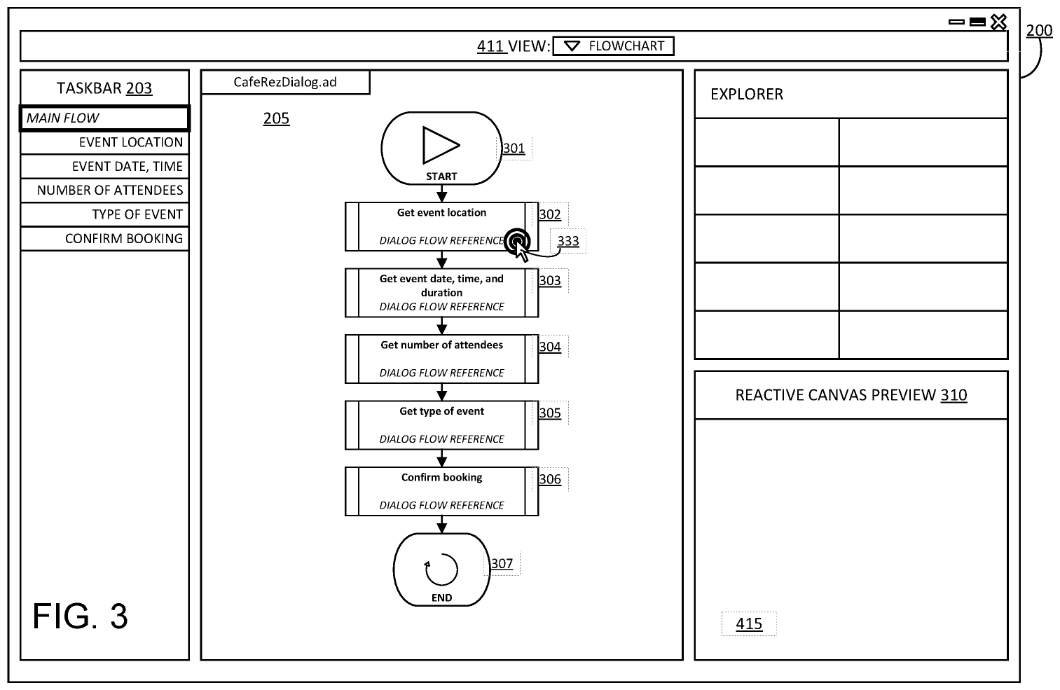

Next referring to FIG. 3, an editing user interface 205 is shown after a developer has entered a series of dialog flow references defining a machine conversation dialog flow. The series of dialog flow references is shown leading from a start block 301 to an end block 307. In operation, the machine conversation dialog flow returns a series of values (slots) from one or more dialog flow reference sub-dialogs once the conversation flow is completed. Taskbar 203 shows the main flow as being highlighted, and as such, the main dialog flow is shown in editing user interface 205. The five dialog flow references 302-306 of the main dialog flow are also shown in the taskbar 203 as indented underneath the main flow block. Selection of a block (represented as a cursor positioned 333 over this block) allows the developer to explore the Get event location dialog flow reference 302 in further detail.

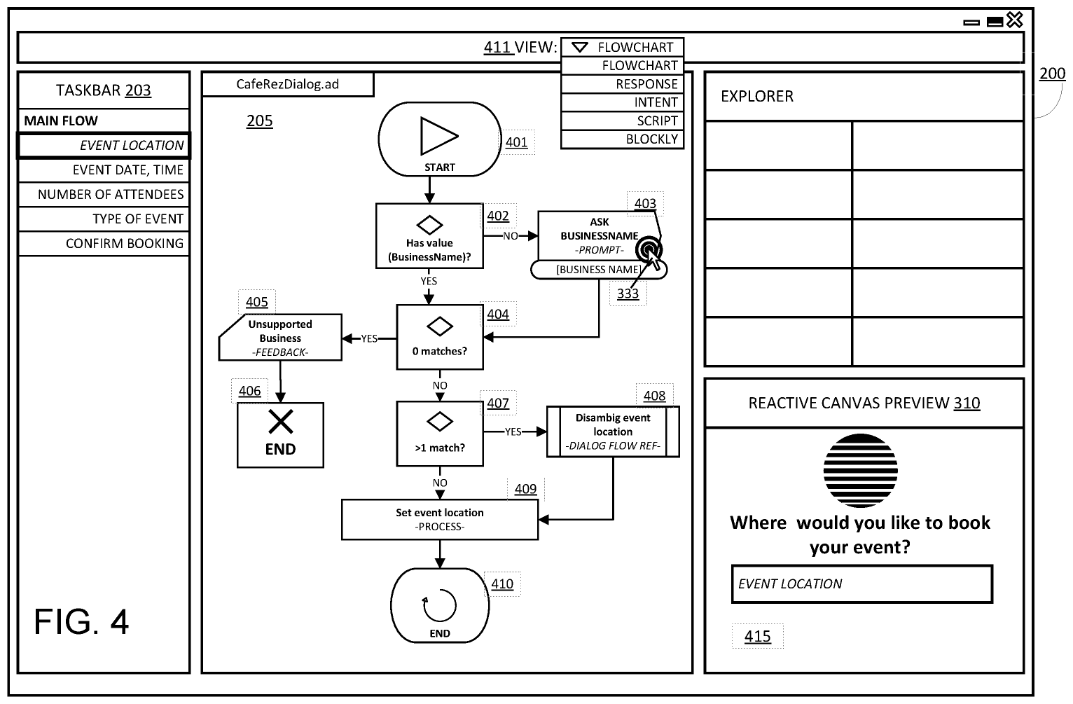

FIG. 4, shows further detail of dialog flow reference 302 from FIG. 3, and illustrates states and transitions of the Get event location dialog flow reference 302 in the editing user interface 205. As shown in taskbar 203, the Event location dialog flow reference underneath the main flow dialog is now selected. Similar to FIG. 3, the dialog sub of FIG. 4 also comprises a start state 401 and an end state 410, and also an end failure state 406. The end failure state 406 in this dialog flow reference represents a state in which the human user participating in the dialog fails to utter a name of a business supported in this dialog flow. In the case that the human user fails to utter the name of a business supported in this dialog flow, the Get event location dialog flow reference 302 may start over again, the user may start the main dialog flow over again, the main dialog flow may be canceled, or any other suitable action may be taken.

Continuing with FIG. 4, selection of an individual state of the dialog flow results in the display of a preview of that state in the UI preview region 415 of the reactive canvas preview 310. In the example of FIG. 4, the preview displayed in the UI preview region 415 shows the ASK BUSINESSNAME state 403 in the context of a digital personal assistant running on a computing device. The preview of a dialog flow state shown in the reactive canvas preview 310 may take any suitable digital context and hardware device context as specified by the developer, including audio contexts (e.g. by presenting audio-only previews as well as audio/visual previews). Further, as described below, a machine conversation dialog flow shown in editing user interface 205 may be previewed in a plurality of different contexts.

Continuing with FIG. 4, the editing user interface 205 comprises a machine conversation dialog flow view selection 411 with different selectable view options that allow the developer to change the visual representation of the conversation flow currently being edited in the editing user interface 205. In the depicted example, the FLOWCHART view is currently selected in the editing user interface view selection 411, and as such, the dialog flow in the editing user interface 205 represents states 401-410 as a flowchart. This view may help a developer visualize the dialog flow.

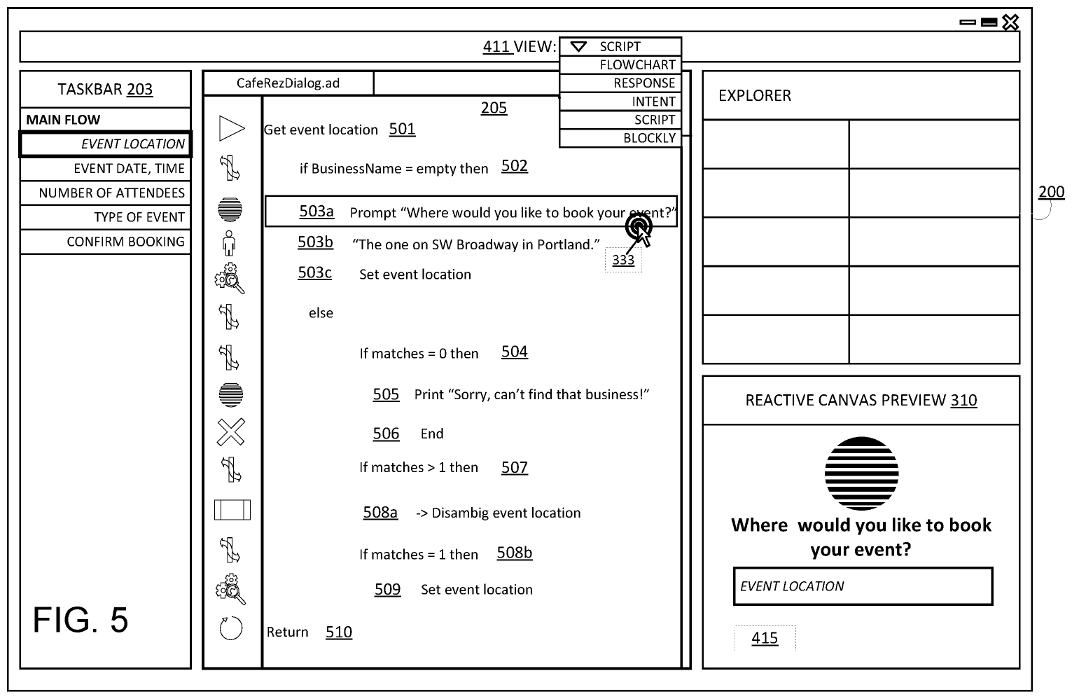

Next regarding FIG. 5, with the Event location dialog flow reference still highlighted in taskbar 203, the developer may switch the editing user interface view selection 411 from FLOWCHART to SCRIPT. As a result, the representation of the dialog flow shown in the editing user interface 205, changes from the flowchart dialog flow visualization of FIG. 4 to a character-based script visualization as shown in FIG. 5. The script view mode may allow a developer to quickly draft a conversation flow if the developer is fluent in the script syntax. As shown in the editing user interface 205, flowchart states 401-410 from FIG. 4 are shown respectively as scripted states 501-510 in FIG. 5, along with visual cues in the column to the left of editing user interface 205, in order to point out the function of each state to the developer. Regardless of the change of view, the reactive canvas preview 310 displays a dialog state in the same manner.

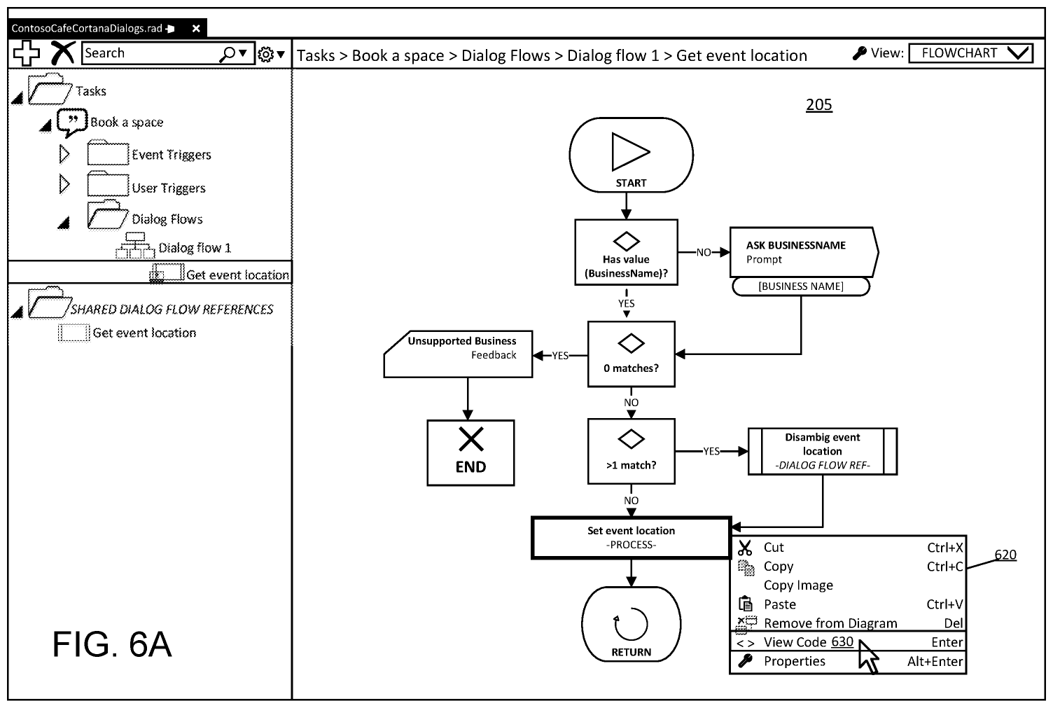

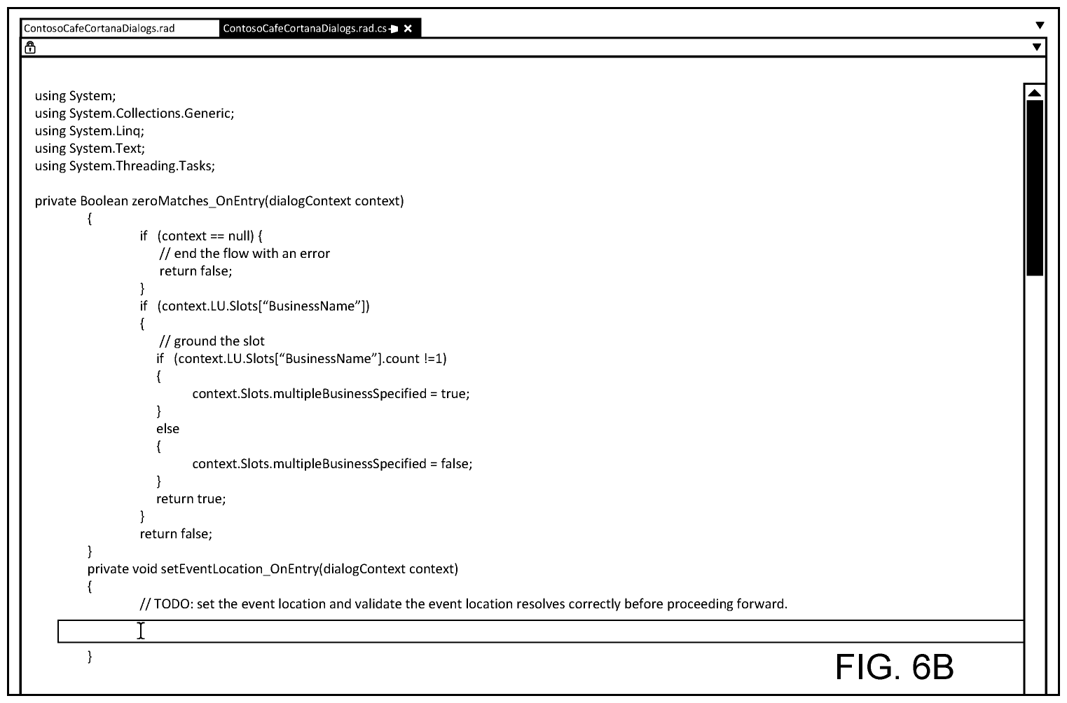

Referring next to FIG. 6A and 6B, a developer may access the programming code behind each state of the dialog flow via the editing user interface 205. In order to access the programming code behind, a developer can select a state of the dialog flow as shown in FIG. 6A, and then select a View Code option 630 from a contextual menu 620. Selecting the View Code option results in the display of the code behind the selected element of the dialog flow. The developer then may edit the code behind in this view, as shown in FIG. 6B, and the edited code behind will be bound to the corresponding state in the dialog flow. Although the representation of the dialog flow in FIG. 6A is in the flowchart view, any view mode of the representation may be used in order to access the programming code behind states.

Further, a developer may select one or more digital contexts for the dialog flow, and separately define responses for each context. For example, as shown in steps 705 and 710 of FIG. 7, a developer can provide responses for fallback (default), audio only (e.g. for in-vehicle use), distracted (e.g. for mobile use), full attention (e.g. for desktop/laptop use), limited display (e.g. for smart watch or other small format display), holographic (e.g. for near-eye displays or other virtual/augmented reality devices), in-app, and bot. Each response template provides different UI features which may be used to automatically adapt the dialog flow to different scenarios without the need for re-designing and re-programming an entire dialog flow for each context. As a more specific example, as shown in the UI preview region 415 of FIG. 7 where a human could provide the location of an event via text or speech input, an in-app response template allows for the definition of a plurality of different user input options for the event location represented by UI objects Location 1, Location 2 and Location 3 in UI preview region 415, thereby supporting user input modes and responses in a variety of device contexts. Further, the preview of the selected state may be displayed within the UI preview region 415 as adapted to a hardware specification of a type of device selected in the UI preview region 415 to show the selected state as it would appear on a computing device having that hardware specification.

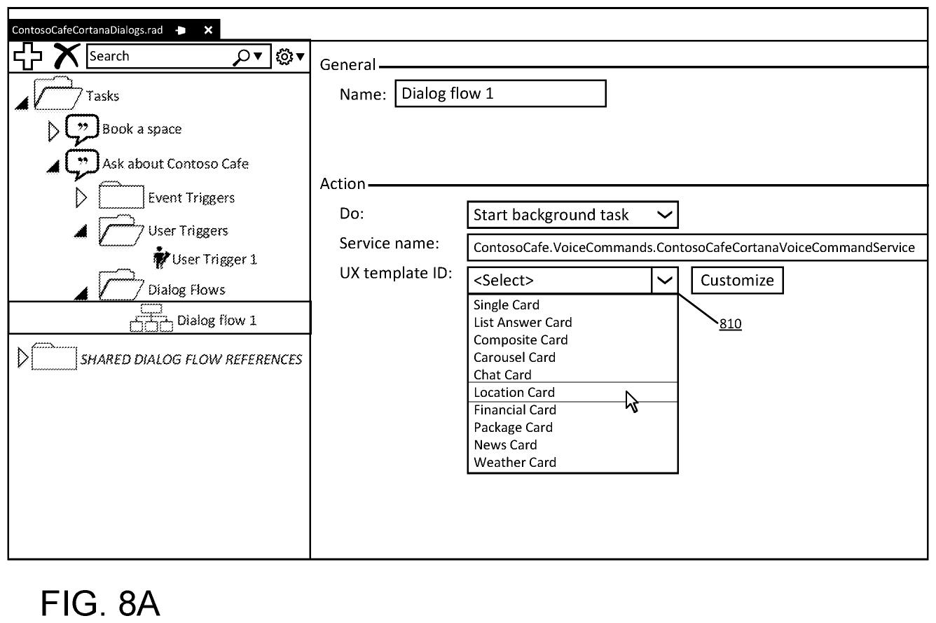

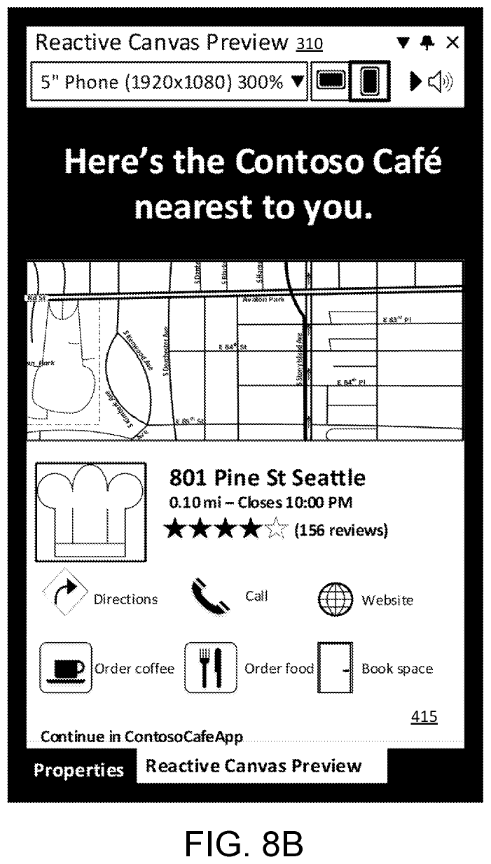

Referring to FIG. 8A and FIG. 8B, the UI preview region 415 can further be utilized to preview visual elements obtained from outside an operating environment of the agent development tool. In FIG. 8A, as an example, the developer is shown selecting a user experience template “location card” from a dropdown menu 810, and a map obtained from an external mapping service is shown in response in the reactive canvas preview 310 in FIG. 8B. Thus, the preview region may support preview of both static and dynamically-obtained information. Further, in some examples the preview region may support text-to-speech so that a developer may actually hear how a conversation sounds.

Once an agent definition has been completed, the agent definition may be installed and run on a developer's local machine for testing by including appropriate code behind in the definition for interaction with the desired operating environment. Further, the agent development environment 102 is configured to allow the developer to share an agent definition with other defined user accounts, and provide feedback and analytic functions 140 to allow the developer to view feedback from testing usage by other users.

First, FIG. 9 illustrates a New Flight Group User Interface 900 configured to allow a developer to specify user accounts grouped into “flight groups” that will be granted access to use the conversation flow under development. As the flight group uses the conversation flow, telemetry may be used to collect information on how the conversation flow is used. Data collected via telemetry then may be used to provide feedback to the developer regarding usage of the machine conversation dialog flow defined by agent definition 142.

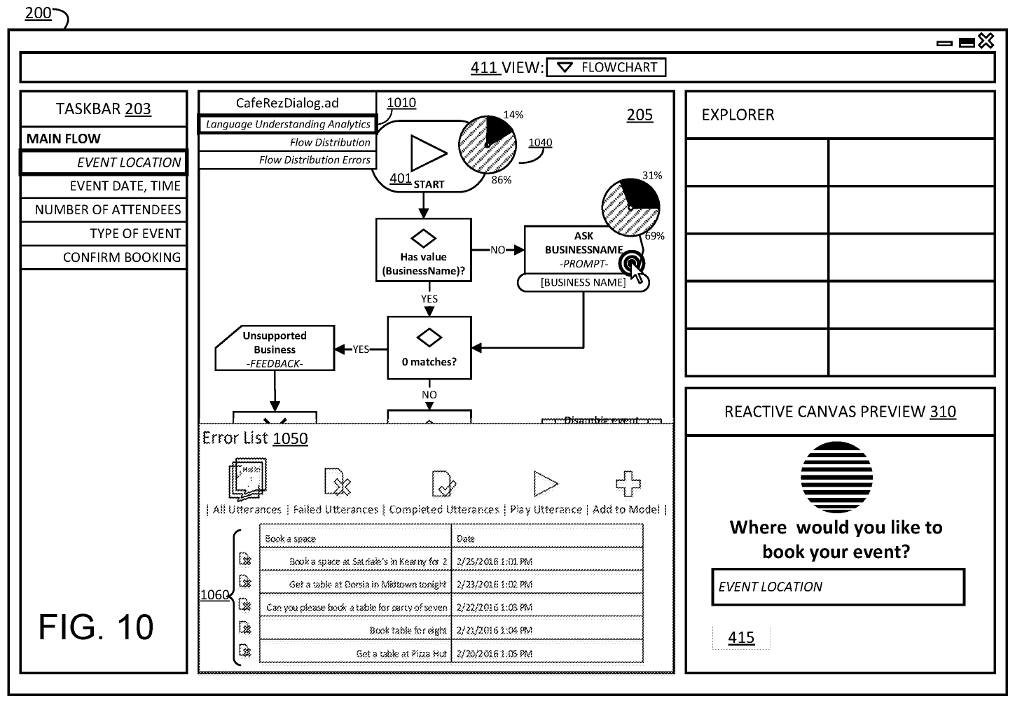

FIG. 10 shows an example representation of feedback displayed to a developer. In this example, switching the current editing user interface view selection 411 to FLOWCHART and selecting the Language Understanding Analytics block 1010 in editing user interface 205 brings up an Error List window 1050 at the bottom of editing user interface 205 and displays the feedback at each state as a visual representation of the number of language understanding successes and failures at each state. The Error List window 1050 at the bottom of editing user interface 205 may display a list of user queries, inputs and/or utterances that failed. A developer may, for example, select a failed query, input and/or utterance that failed and modify the language understanding model in a way such that the failed query, input and/or utterance is understood. For example, at the START state 401 of FIG. 10, the corresponding pie graph visualization 1040 shows that 86% of the input by users of the flight group were successfully understood at that state, while 14% were unsuccessful. The number of language understanding successes and failures could be shown by any other suitable visualization.

The Error List window 1050 of FIG. 10, as an example, can display all utterances, failed utterances and completed utterances of the flight group for the developer to see. In the illustrated example of FIG. 10, the utterances may be text inputs from the users of text acquired from speech-to-text. The Error List 1060 displays feedback from 5 language understanding failures, textual representations of the user inputs, and the date and time when the feedback was acquired.

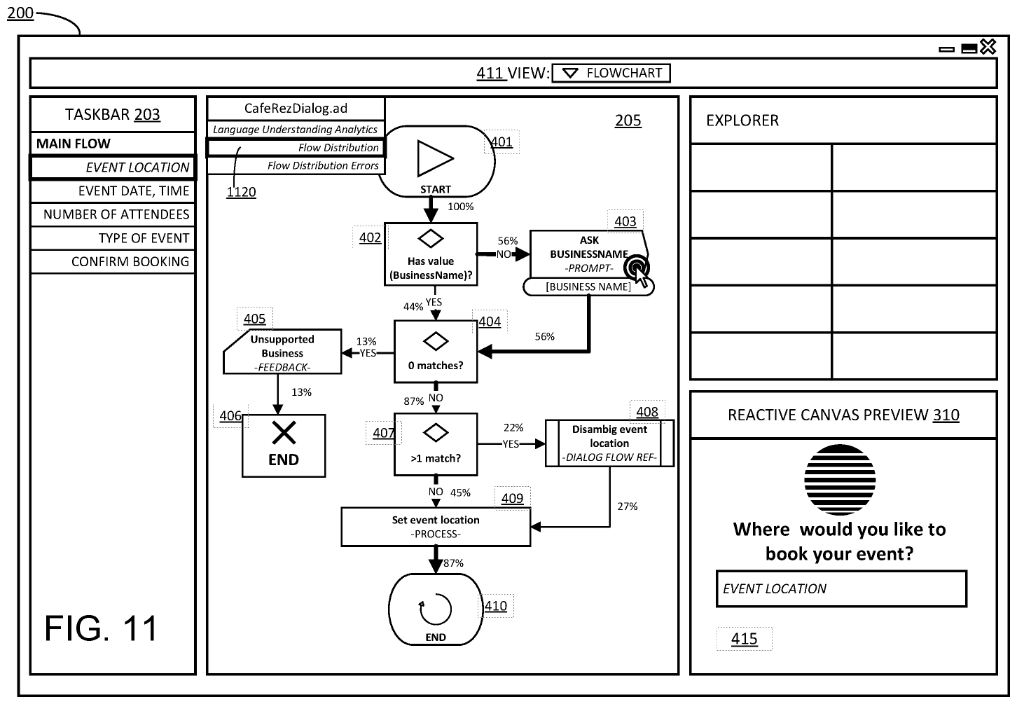

As illustrated by example in FIG. 11, the feedback and in-line analytics 140 further may be configured to provide a Flow Distribution representation of feedback 1120 in the editing user interface 205. As an example, the Flow Distribution representation of feedback 1120 may display a representation of a number of users taking a particular pathway through the dialog flow. Such feedback may provide the developer with a visual understanding of the traffic flow through the conversation, and may facilitate modifying the dialog flow to make it more efficient or user-friendly. For example, referring to FIG. 11, if a developer sees that 13% of users at “0 matches?” state 404 asked about an unsupported business and are going on to the END failure state 406, without returning an event location to the main dialog flow, this may indicate that the ASK BUSINESSNAME state 403 should be modified so that fewer users end up at the END failure state 406 without returning an event location.

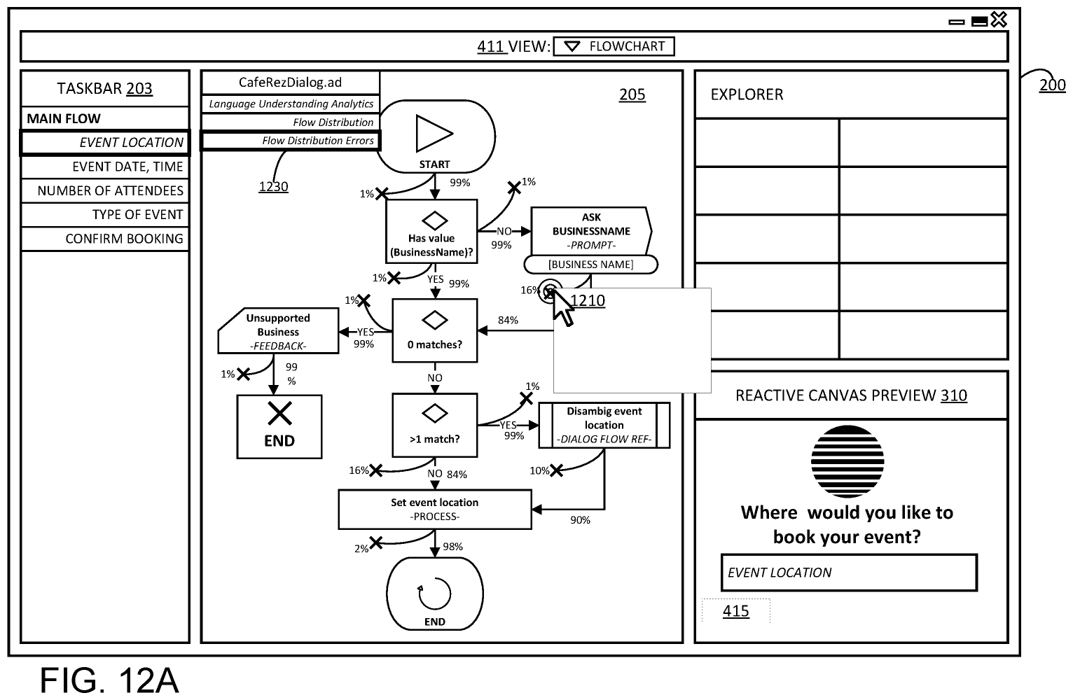

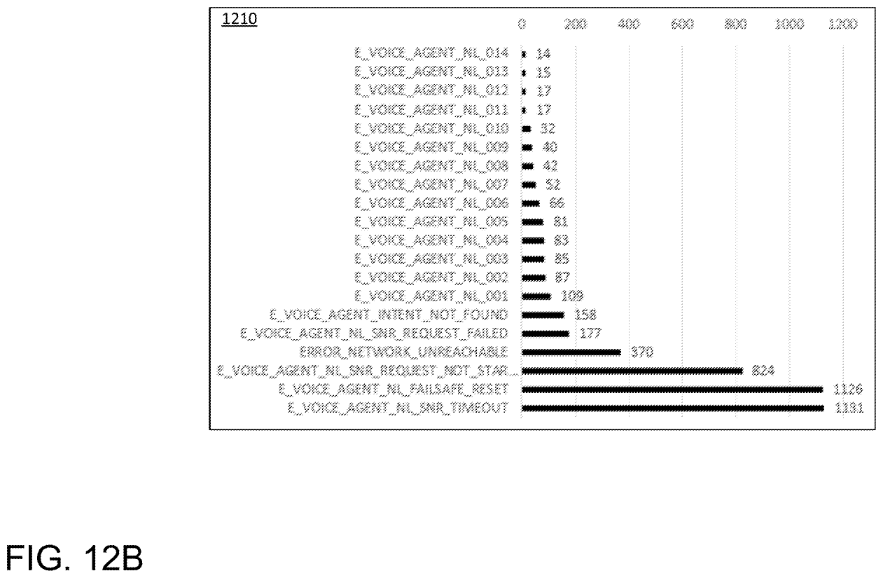

As illustrated by example in FIGS. 12A-B, the feedback and in-line analytics 140 further may provide a Flow Distribution Errors representation of feedback 1230 in the editing user interface 205. The Flow Distribution Errors representation 1230 shows, as an example, a number of user dropouts (where users exit the flow) at each state transition. With FIGS. 12A-B as an example, these dropouts are represented by failure arcs, one of which is shown by selected failure arc 1210. Selecting a failure arc 1210 displays a breakdown of technical failure reasons to provide to the developer for debugging and troubleshooting.

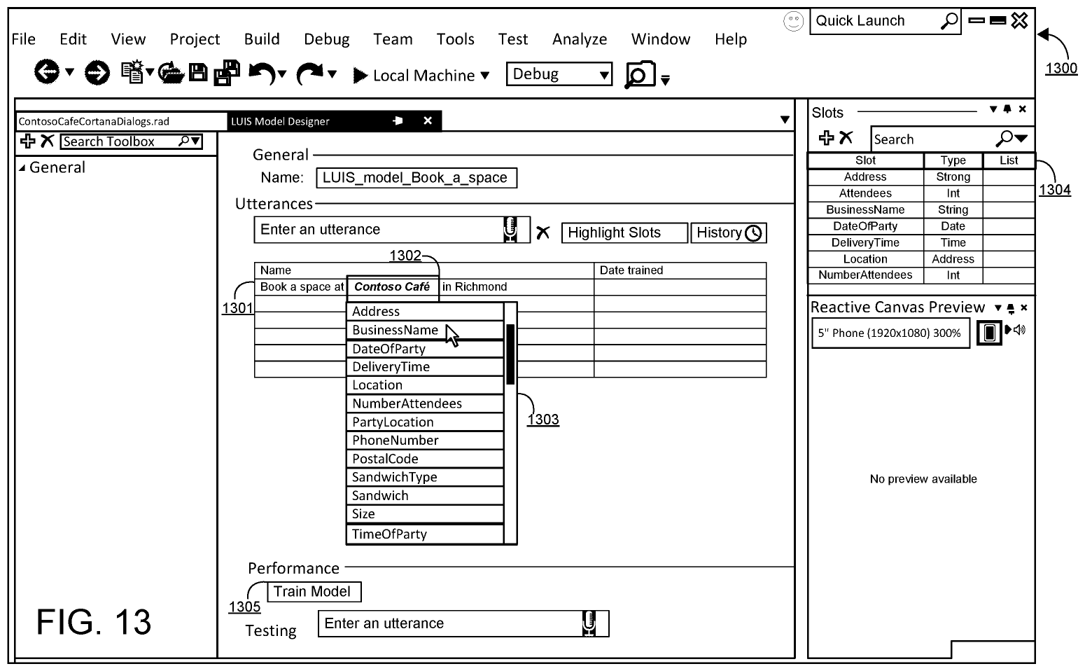

As mentioned above with regard to FIG. 10, for a failed query, input, and/or utterance, a developer may modify a language understanding model in a way such that the failed query, input and/or utterance is less likely not to be understood. A language understanding model may be used to help accurately capture user intent and/or further define a user trigger. FIG. 13 illustrates an example user interface 1300 for a Language Understanding Model Designer that a developer may use to create and/or modify a language understanding model. For example, a developer may record sample utterances 1301 for the language understanding model via the user interface 1300. The developer may highlight words and/or phrases 1302 to associate slots 1303 (e.g. date, time, location) with the words or phrases 1302 in a sample utterance 1301 to allow the machine conversational dialog flow to detect user intents via inputs made during a machine conversation dialog flow. A list of pre-defined slots 1304 (e.g. to assign uttered words and/or phrases with an intent) may be available to a developer in the Language Understanding Model Designer 1300.

In some examples, to predict whether expected user utterances will be identified and understood, a developer may train and test a language understanding model. For example, in FIG. 13, selecting a “train model” user interface element 1305 may train a language understanding model to identify user intent and extract corresponding slots 1302, if any, of user input 1301. A developer may additionally test a language understanding model, in some examples, by speaking or typing a phrase and receiving an indication of slots recognized within the phrase. Training and testing a language understanding model using sample utterances may increase language understanding successes in the machine conversation dialog flow.

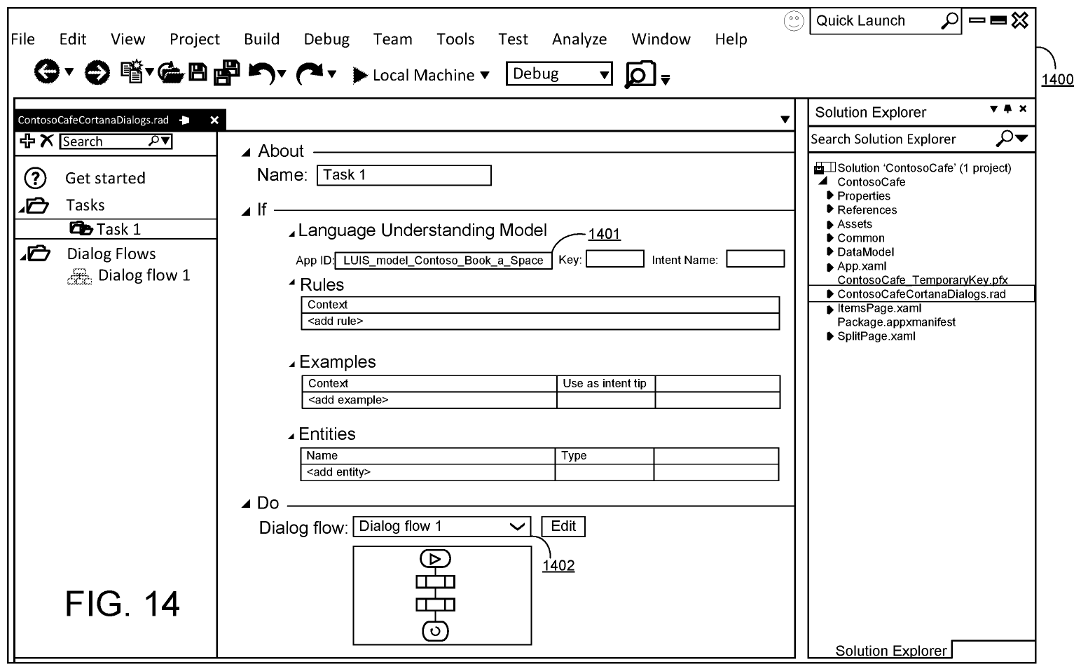

The agent development tool further is configured to allow a language understanding model to be assigned to a dialog flow. FIG. 14 shows a user interface 1400 for assigning a language understanding model 1401 to a dialog flow 1402. In this example, a developer may select a language understanding model 1401 from one or more language understanding models and a dialog flow 1402 from one or more dialog flows to assign the language understanding model 1401 to the dialog flow 1402. As shown in FIG. 14, example utterances, rules, and other entities associated with the language understanding model 1401 may be visible to a developer via the example user interface to view and/or modify.

As mentioned above, a preview of the selected state may be displayed within the machine conversation dialog flow as adapted to a type of device selected in the user interface. FIG. 15A and FIG. 15B show examples of a dialog flow adapted to different digital contexts. FIG. 15A illustrates the dialog flow adapted to a mobile device 1500 with which a user can provide text or speech input in order to order food or book a space at Café du Chat through the use of a bot. FIG. 15B shows the same dialog flow adapted to a desktop computing device 1510, allowing for a more elaborate user interface. In addition to a bot chat similar to that of FIG. 15A, FIG. 15B also includes selectable user interface elements which a visitor to CaféduChat.com may use, instead of the bot chat, to make a reservation or order food. As previously stated, the dialog flows may be adapted to any suitable context using the agent development environment 102. As a further example, the Café du Chat dialog flow may be adapted to an audio-only dialog, in which a user only spoke with a bot in a convenient, hands-free scenario, through a mobile phone conversation or a web-based audio chat.

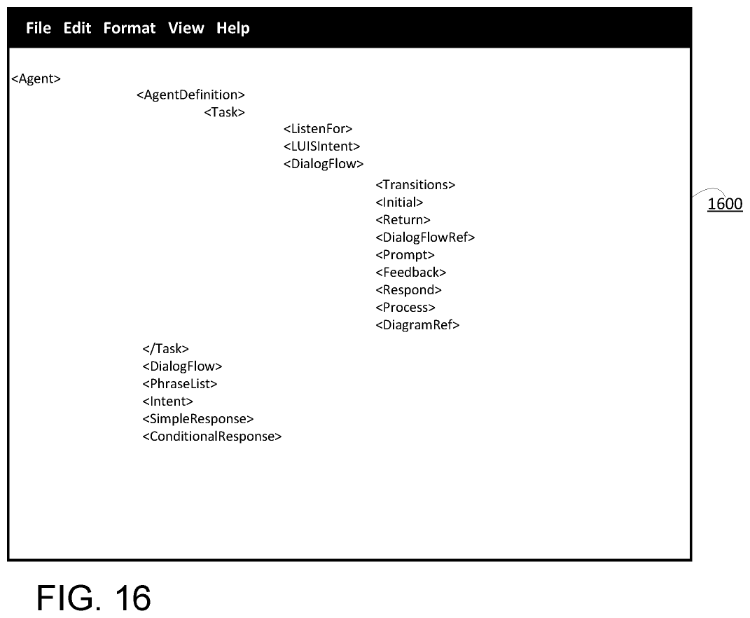

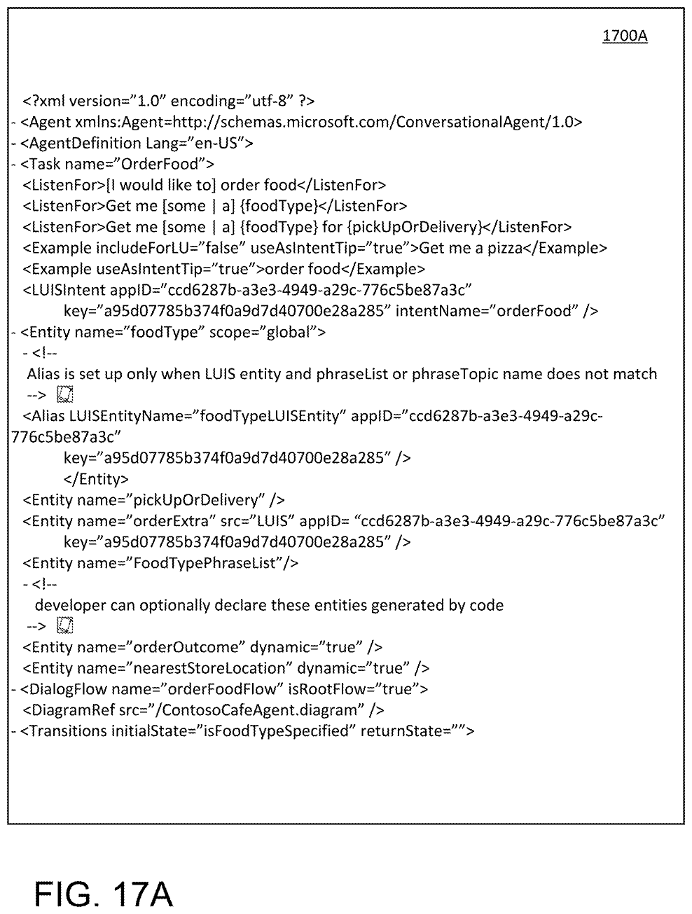

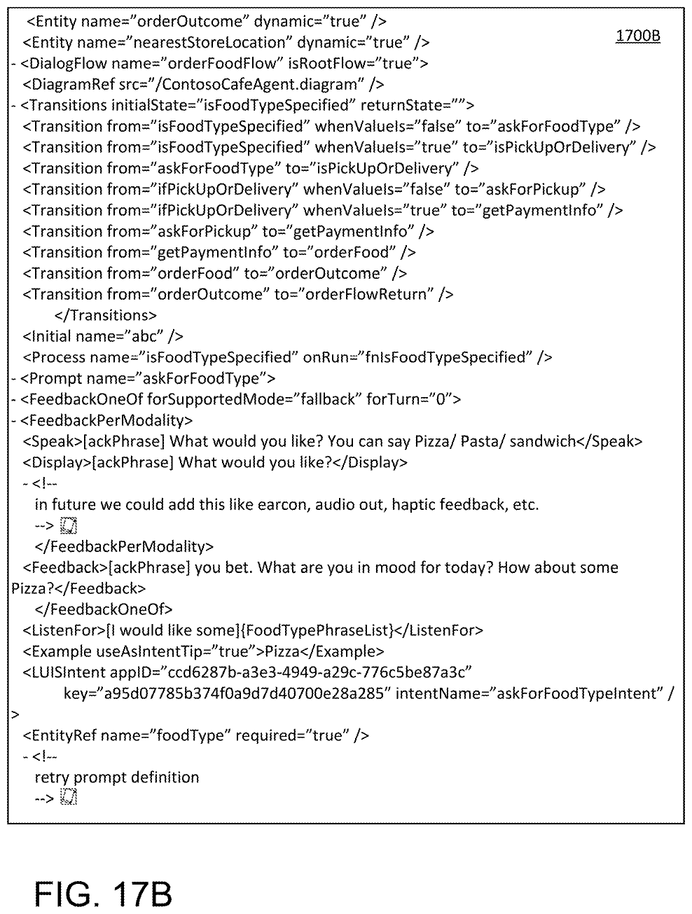

FIG. 16 shows an example schema template 1600 that may be used for generating an agent definition. Schema template 1600 is an example of a schema template that may be used as schema template 132 of FIG. 1 Schema template 1600 includes a plurality of code segments which may be updated by the agent generator 128 to create an updated schema 104 for an agent definition 142. FIGS. 17A-B illustrate an example updated schema 1700 used in an agent definition, wherein the updated schema includes a plurality of code segments updated by the agent generator 128. Updated schema 1700 is an example of updated schema 104 of FIG. 1.

In some examples, the methods and processes described herein may be tied to a computing system of one or more computing devices. In particular, such methods and processes may be implemented as a computer-application program or service, an application-programming interface (API), a library, and/or other computer-program product.

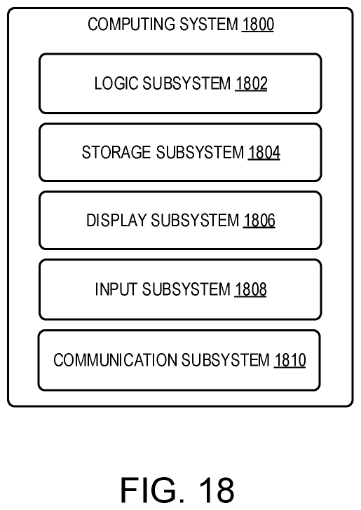

FIG. 18 schematically shows a non-limiting embodiment of a computing system 1800 that can enact one or more of the methods and processes described above. Computing system 1800 is shown in simplified form. Computing system 1800 may take the form of one or more personal computers, server computers, tablet computers, home-entertainment computers, network computing devices, gaming devices, mobile computing devices, mobile communication devices (e.g., smart phone), and/or other computing devices.

Computing system 1800 includes a logic subsystem 1802 and a storage machine 1804. Computing system 1800 may optionally include a display subsystem 1806, input subsystem 1808, communication subsystem 1810, and/or other components not shown in FIG. 18.

Logic subsystem 1802 includes one or more physical devices configured to execute instructions. For example, the logic subsystem may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic subsystem may include one or more processors configured to execute software instructions. Additionally or alternatively, the logic subsystem may include one or more hardware or firmware logic machines configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely accessible, networked computing devices configured in a cloud-computing configuration.

Storage subsystem 1804 includes one or more physical devices configured to hold instructions executable by the logic subsystem to implement the methods and processes described herein. When such methods and processes are implemented, the state of storage subsystem 1804 may be transformed—e.g., to hold different data.

Storage subsystem 1804 may include removable and/or built-in devices. Storage subsystem 1804 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1804 may include volatile, nonvolatile, dynamic, static, read/write, read-only, random-access, sequential-access, location-addressable, file-addressable, and/or content-addressable devices.

It will be appreciated that storage subsystem 1804 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1802 and storage subsystem 1804 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1800 implemented to perform a particular function. In some cases, a module, program, or engine may be instantiated via logic subsystem 1802 executing instructions held by storage subsystem 1804. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1806 may be used to present a visual representation of data held by storage subsystem 1804. This visual representation may take the form of a graphical user interface (GUI). As the herein described methods and processes change the data held by the storage machine, and thus transform the state of the storage machine, the state of display subsystem 1806 may likewise be transformed to visually represent changes in the underlying data. Display subsystem 1806 may include one or more display devices utilizing virtually any type of technology. Such display devices may be combined with logic subsystem 1802 and/or storage machine 1804 in a shared enclosure, or such display devices may be peripheral display devices.

When included, input subsystem 1808 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1810 may be configured to communicatively couple computing system 1800 with one or more other computing devices. Communication subsystem 1810 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1800 to send and/or receive messages to and/or from other devices via a network such as the Internet.

Another example provides a computing system comprising a logic subsystem and a data-holding subsystem comprising computer-readable instructions executable by the logic system to receive input defining a machine conversation dialog flow, display in an editing user interface a first representation of the machine conversation dialog flow in the form of a symbolic representation, receive input requesting display of a second representation of the machine conversation dialog flow, in response to the request, display in the editing user interface the machine conversation dialog flow in a character-based representation, and based upon the machine conversation dialog flow, update a machine conversation schema template to form an updated machine conversation schema, and form an agent definition file based upon the updated machine conversation schema for use in executing the machine conversation dialog flow. The instructions may be additionally or alternatively executable to display in the editing user interface the symbolic representation as a flow diagram comprising states of the machine conversation in symbol form, and the character-based representation as a script view comprising states of the machine conversation in character form. The instructions may be additionally or alternatively executable to selectively display the machine conversation in the editing user interface via one or more other views than the flow diagram view and the script view. The instructions may be additionally or alternatively executable to receive, via the editing user interface input, user inputs additional states in the machine conversation dialog flow via the symbolic representation and also via the character-based representation. The instructions may be additionally or alternatively executable to receive an input selecting a selected flow diagram symbol in the symbolic representation of the machine conversation dialog flow, and in response display in the editing user interface editable code that is executable at a state in the machine conversation dialog flow represented by the selected flow diagram symbol. The instructions may be additionally or alternatively executable to receive an input selecting a selected state in a currently displayed representation of the machine conversation dialog flow, and to display a preview representing an appearance of a runtime user interface at the selected state in a preview field of the editing user interface. The instructions may be additionally or alternatively executable to receive a user input comprising one or more of a speech input and a text input to further define a selected state within the machine conversation dialog flow. The instructions may be additionally or alternatively executable to receive user inputs of a plurality of different types of triggers configured to initiate the machine conversation in runtime, the plurality of different types of triggers comprising a user input-based trigger type and an event-based trigger type. The instructions may be additionally or alternatively executable to display a user interface configured to permit adaptation of the machine conversation dialog flow to a plurality of different device contexts, and to receive inputs of runtime user interface presentation settings for each of the different types of device contexts.

Another example provides a computing system comprising a logic subsystem and a data-holding subsystem comprising computer-readable instructions executable by the logic system to operate an agent development environment configured to receive input defining a machine conversation dialog flow, display an editable representation of the machine conversation dialog flow in an editing field of a user interface of the agent development environment, receive an input selecting a state within the machine conversation dialog flow displayed in the editing field, in response, display in a preview field of the user interface a preview of the state within the machine conversation dialog flow as the state would be presented during runtime, and based upon the input defining the machine conversation dialog flow, update a machine conversation schema template to form an updated machine conversation schema, and form an agent definition file based upon the updated machine conversation schema for use in executing the machine conversation dialog flow. The instructions may be additionally or alternatively executable to display the preview of the selected state within the machine conversation dialog flow as adapted to a type of device selected in the user interface. The instructions may be additionally or alternatively executable to display in the user interface a list of selectable hardware specifications for the type of device, receive input of a selected hardware specification, and display the preview of the selected state as the selected state would be presented in on a computing device having the selected hardware specification. The preview may additionally or alternatively comprise visual elements obtained for the preview from outside of an operating environment of the agent development environment.

Another example provides a computing system, comprising a logic subsystem and a data-holding subsystem comprising computer-readable instructions executable by the logic system to receive input defining a machine conversation dialog flow, based upon the input, modify a machine conversation schema template to form an agent definition receive an input requesting sharing of the agent definition, the input defining user accounts with which to grant access to the agent definition, grant access to the machine conversation dialog flow to the user accounts defined, receive feedback regarding testing usage of the agent definition from the user accounts, receive an input requesting display of a representation of the feedback regarding testing usage of the agent definition from the user accounts, and in response, display a representation of the machine conversation dialog flow and the representation of the feedback at one or more locations within the representation of the machine conversation dialog flow. The instructions may be additionally or alternatively executable to display the feedback by displaying a representation of a number of times a pathway between states was followed. The instructions may be additionally or alternatively executable to display the feedback by displaying a representation of a number of dropouts of user accounts at each of a plurality of states of the machine conversation dialog flow. The instructions may be additionally or alternatively executable to display the feedback by displaying a representation of a number of successful language understandings at a location of the machine conversation dialog flow, wherein each successful language understandings represents an instance of the machine conversation dialog flow recognizing a user input, and displaying a representation of a number of unsuccessful language understanding at the location of the machine conversation dialog flow, wherein each unsuccessful language understanding represents an instance of the machine conversation dialog flow not recognizing the user input. The instructions may be additionally or alternatively executable to receive an input via the editing user interface selecting a selected state in the machine conversation dialog flow, and in response provide an output of a user input received during testing usage that was not understood at the selected state. The instructions may be additionally or alternatively executable to modify a language understanding model such that an unsuccessful user query, input, or utterance is understood. Receiving feedback regarding testing usage of the agent definition from the user accounts may be additionally or alternatively comprise using telemetry to collect information on how the conversation flow is used.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a logic subsystem; and
a data-holding subsystem comprising computer-readable instructions executable by the logic subsystem to
receive input defining a machine conversation dialog flow comprising a plurality of states and one or more connections between states, the connections between states indicating state transitions;
based upon the input, modify a machine conversation schema template to form an agent definition;
receive an input requesting sharing of the agent definition, the input defining user accounts with which to grant access to the agent definition;
grant access to the machine conversation dialog flow to the user accounts defined;
receive feedback regarding usage of the agent definition from the user accounts;
receive an input requesting display of a representation of the feedback regarding usage of the agent definition from the user accounts; and
in response, display a representation of flow distribution errors of the machine conversation dialog flow.

2. The computing system of claim 1, wherein the usage of the agent definition from the user accounts comprises testing usage.

3. The computing system of claim 1, wherein the representation of flow distribution errors indicating, for each of one or more state transitions, a number of user dropouts associated with the state transition.

4. The computing system of claim 3, wherein the instructions are further executable to, upon receiving an input selecting a state transition, display a graphical representation indicating one or more failure reasons associated with the selected state transition.

5. The computing system of claim 4, wherein the instructions are further executable to indicate via the representation a number of occurrences of each of the one or more failure reasons.

6. The computing system of claim 1, wherein the instructions are further executable to receive a user input selecting a device type, and to adapt the representation of flow distribution errors to the device type selected.

7. The computing system of claim 1, wherein the instructions executable to receive feedback regarding usage of the agent definition from the user accounts further comprise instructions executable to collect information via telemetry.

8. The computing system of claim 1, wherein the instructions are further executable to display via the representation a number of occurrences of the user accounts taking a particular pathway through the dialog flow.

9. Enacted on a computing system, a method of representing feedback regarding usage of a machine conversation dialog, the method comprising:
receiving user inputs defining a machine conversation dialog flow comprising a plurality of states and one or more connections between states, the one or more connections between states indicating state transitions;
modifying a machine conversation schema template to form an agent definition;
sharing the agent definition to defined user accounts with which to grant access to the agent definition;
granting access to the machine conversation dialog flow to the defined user accounts;
receiving feedback regarding usage of the agent definition from the user accounts;
displaying a representation of the feedback regarding usage of the agent definition from the user accounts; and
displaying a representation of flow distribution errors of the machine conversation dialog flow based upon the feedback.

10. The method of claim 9, wherein the usage of the agent definition from the user accounts comprises testing usage.

11. The method of claim 10, further comprising indicating, for each of one or more state transitions, a number of user dropouts associated with the state transition in the representation of flow distribution errors.

12. The method of claim 11, further comprising displaying, upon receiving an input selecting a state transition, a graphical representation indicating one or more failure reasons associated with the selected state transition.

13. The method of claim 12, further comprising indicating via the representation a number of occurrences of each of the one or more failure reasons.

14. The method of claim 10, further comprising receiving a user input selecting a device type, and adapting the representation of flow distribution errors to the device type selected.

15. The method of claim 10, wherein receiving feedback regarding usage of the agent definition from the user accounts further comprises collecting information via telemetry.

16. The method of claim 10, further comprising displaying via the representation a number of occurrences of the user accounts taking a particular pathway through the dialog flow.

17. Enacted on a computing system, a method comprising:
receiving user inputs defining a machine conversation dialog flow comprising a plurality of states and one or more connections between states, the one or more connections between states indicating state transitions;
assigning a language understanding model to the machine conversation dialog flow;
receiving feedback regarding usage of the machine conversation dialog flow from one or more user accounts;
based at least upon the feedback, displaying a representation of flow distribution errors of the machine conversation dialog flow;
receiving a user input selecting a state transition;
displaying, in response to receiving the input selecting a state transition, a textual representation of one or more failed user language inputs from the user accounts for the selected state transition; and
receiving a user input modifying the language understanding model.

18. The method of claim 17, wherein displaying the feedback further comprises displaying a representation of the number of occurrences of language understanding failures and successes at each state.

19. The method of claim 17, wherein receiving a user input modifying the language understanding model comprises receiving a user input of sample utterances corresponding to a selected failed user language input of the one or more failed user language inputs, and training the language understanding model using the sample utterances.

20. The method of claim 17, wherein the language understanding model links one or more words and phrases to a specific.
